(19) United States
(12) Patent Application Publication
(10) Pub. No.: US 2016/0121887 A1
(43) Pub. Date: May 5, 2016

(54) APPARATUS AND METHOD FOR DETECTING COLLISION OBJECT OF VEHICLE

(71) Applicant: HYUNDAI MOTOR COMPANY, Seoul (KR)

(72) Inventor: Dae Seok JEON, Hwaseong-si (KR)

(21) Appl. No.: 14/730,209

(22) Filed: Jun. 3, 2015

(30) Foreign Application Priority Data
Nov. 4, 2014 (KR) 10-2014-0152422

(51) Int. Cl. B60W 30/095

(52) U.S. Cl. CPC B60W 30/0956; B60W 2550/30

(57) ABSTRACT

An apparatus for detecting a collision object of a vehicle senses one or more relative vehicles positioned in front of an own vehicle through sensors provided in the own vehicle and collects relative vehicle information on the sensed relative vehicles, calculates relative positions of the relative vehicles when the own vehicle and the relative vehicles arrive at the same line in consideration of prediction paths of the own vehicle and the relative vehicles, selects a collision type depending on relative velocity relationships and access angles of the relative vehicles, calculates a collision position between the own vehicle and the relative vehicles in the selected collision type, calculates collision information based on the collision position, and selects a collision object among the one or more relative vehicles based on the collision information.

### CROSS-REFERENCE TO RELATED APPLICATION

This application is based on and claims the benefit of priority to Korean Patent Application No. 10-2014-0152422, filed on Nov. 4, 2014 in the Korean Intellectual Property Office, the disclosure of which is incorporated herein in its entirety by reference.

### TECHNICAL FIELD

The present disclosure relates to an apparatus and a method for detecting a collision object of a vehicle, and more particularly, to an apparatus and a method for detecting a collision object of a vehicle capable of selecting only a vehicle having collision possibility among vehicles that are sensed in front of the own vehicle when the own vehicle is being driven.

### BACKGROUND

Generally, a collision avoidance system (CAS) senses front obstacles through sensors mounted in a vehicle and collects and analyzes information on the front obstacles to warn a driver of a collision danger or directly control braking, steering, and the like, of the vehicle.

The collision avoidance system measures a distance and a relative velocity to a front vehicle through the sensors. In addition, the collision avoidance system decides a collision danger based on the distance and the relative velocity to the front vehicle to warn the driver of the collision danger and directly control the braking and the steering of the vehicle, thereby inducing collision avoidance or collision damage alleviation.

However, as disclosed in Patent Document 1, since the collision avoidance system according to the related art decides collision possibility only for the front vehicle positioned on a course of an own vehicle, it may not decide whether or not the own vehicle will collide with a vehicle crossing with the own vehicle or a vehicle moving in an opposite direction to a direction in which the own vehicle moves.

### RELATED ART DOCUMENT

### Patent Document

(Patent Document 1) KR100614282 B1

### SUMMARY

The present disclosure has been made to solve the above-mentioned problems occurring in the prior art while advantages achieved by the prior art are maintained intact.

An aspect of the present disclosure provides an apparatus and a method for detecting a collision object of a vehicle capable of selecting only a vehicle having collision possibility among vehicles that are sensed in front of the own vehicle when the own vehicle is being driven.

According to an exemplary embodiment of the present disclosure, a method for detecting a collision object of a vehicle includes: sensing one or more relative vehicles positioned in front of an own vehicle through sensors provided in the own vehicle and collecting relative vehicle information on the sensed relative vehicles; calculating relative positions of the relative vehicles when the own vehicle and the relative vehicles arrive at the same line in consideration of prediction paths of the own vehicle and the relative vehicles; selecting a collision type depending on relative velocity relationships and access angles of the relative vehicles; calculating a collision position between the own vehicle and the relative vehicles in the selected collision type; calculating collision information based on the collision position; and selecting a collision object among the one or more relative vehicles based on the collision information.

The relative vehicle information may include a velocity, a movement direction, a relative position, a width, and a length of the relative vehicle.

The relative position may be a distance between the own vehicle and the relative vehicle in a transversal direction.

In the calculating of the relative positions of the relative vehicles, distances between the own vehicle and the relative vehicles in a transversal direction may be calculated in a point in time in which the own vehicle and the relative vehicles arrive at the same line.

The prediction paths may be calculated by assuming that each vehicle is movement of points and applying a circle equation or a polynomial equation.

The selecting of the collision type may include deciding whether or not the own vehicle and the relative vehicle collide with each other based on sizes of the own M vehicle and the relative vehicle.

The collision information may include a time to collision (TTC) between the own vehicle and the relative vehicle, a collision overlap, and a collision angle.

The calculating of the collision information may include: calculating a collision point in time using a distance between the own vehicle and the relative vehicle in a transversal direction on the same line, a distance between the own vehicle and the relative vehicle in the transversal direction at the collision position, and a relative velocity in the transversal direction; and calculating the TTC using a point in time in which the own vehicle and the relative vehicle arrive at the same line and the collision point in time.

According to another exemplary embodiment of the present disclosure, an apparatus for detecting a collision object of a vehicle includes: a relative vehicle information obtaining unit configured to sense one or more relative vehicles positioned in front of an own vehicle through sensors provided in the own vehicle and collect relative vehicle information on the sensed relative vehicles; an own vehicle information obtaining unit configured to collect information on the own vehicle; and a processor configured to calculate relative positions of the relative vehicles when the own vehicle and the relative vehicles arrive at the same line in consideration of prediction paths of the own vehicle and the M relative vehicles, select a collision type depending on relative velocity relationships and access angles of the relative vehicles, calculate a collision position between the own vehicle and the relative vehicles in the selected collision type, calculate collision information based on the collision position, and select a collision object among the one or more relative vehicles based on the collision information.

The relative vehicle information may include a velocity, a movement direction, a relative position, a width, and a length of the relative vehicle.

The own vehicle information may include a width, a length, a movement direction, and a vehicle velocity of the own vehicle.

The processor may calculate the prediction paths by assuming that the own vehicle and the relative vehicle are one points and applying a circle equation or a polynomial equation.

The processor may calculate the collision position between the own vehicle and the relative vehicle in consideration of widths and lengths of the own vehicle and the relative vehicle.

### BRIEF DESCRIPTION OF THE DRAWINGS

The above and other objects, features and advantages of the present disclosure will be more apparent from the following detailed description taken in conjunction with the accompanying drawings.

FIG. 1 is a block diagram illustrating a configuration of an apparatus for detecting a collision object of a vehicle according to an exemplary embodiment of the present disclosure.

FIG. 2 is a view for describing a position relationship between an own vehicle and a relative vehicle according to the exemplary embodiment of the present disclosure.

FIG. 3 is a view for describing calculation of a distance difference between the own vehicle and the relative vehicle in a transversal direction through coordination conversion according to the exemplary embodiment of the present disclosure.

FIG. 4 is a view illustrating collision types according to the exemplary embodiment of the present disclosure.

FIG. 5 is a view for describing collision position calculation according to the exemplary embodiment of the present disclosure.

FIG. 6 is a flow chart illustrating a method for detecting a collision object of a vehicle according to the exemplary embodiment of the present disclosure.

FIG. 7 is a view for describing collision object selection according to the exemplary embodiment of the present disclosure.

### DETAILED DESCRIPTION

Since the terms “include”, “is configured of”, “have”, and the like, described in the present specification mean the inclusion of corresponding components unless particularly described otherwise, they will mean the inclusion of other components but not the exclusion of other components.

The terms “part”, “module”, and the like, described in the specification mean a unit of processing at least one function or operation and may be implemented by hardware or software or a combination of hardware and software. In addition, terms “one”, “a”, “the”, and the like, may be used as the meaning including both of the singular number and the plural number unless described otherwise in the present specification in a context describing the present disclosure or clearly contradicted by the context.

Hereinafter, exemplary embodiments of the present disclosure will be described in detail with reference to the accompanying drawings.

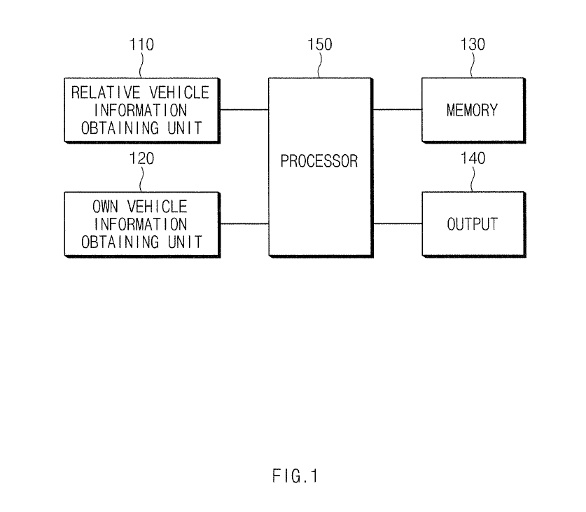

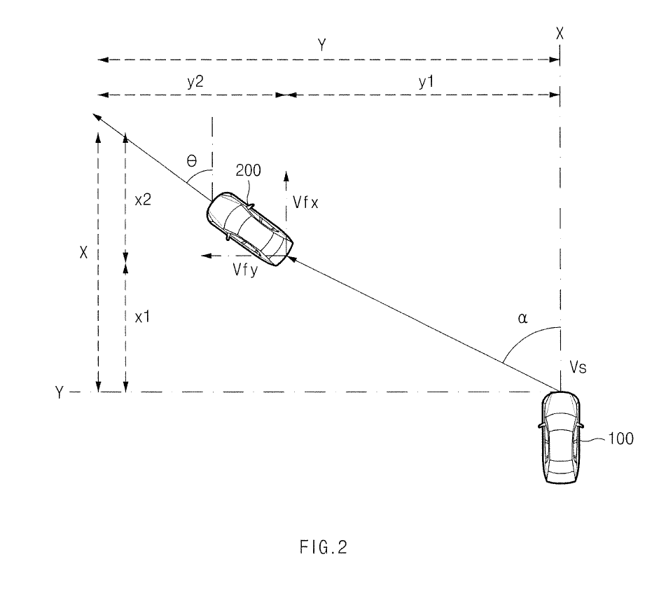

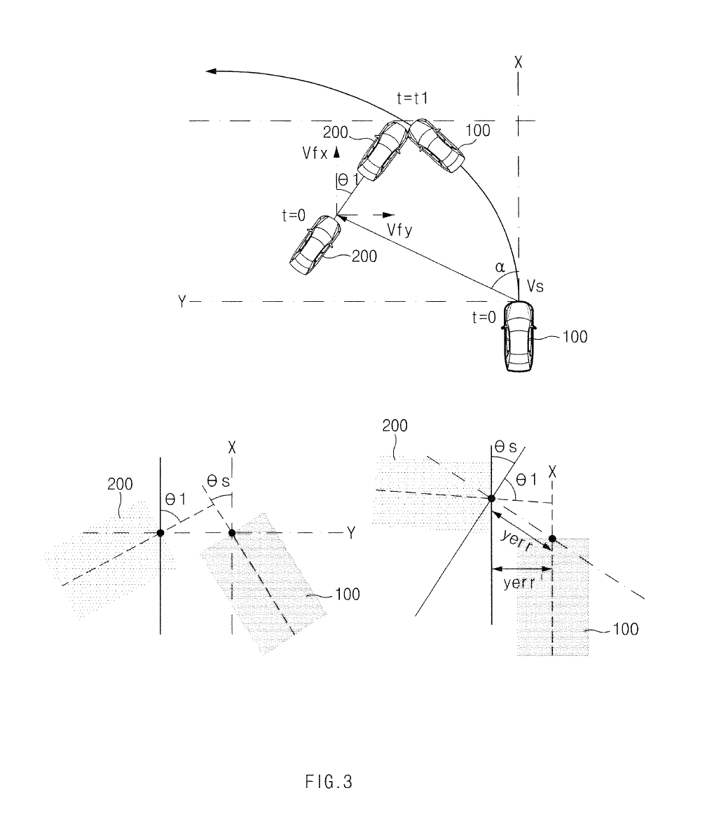

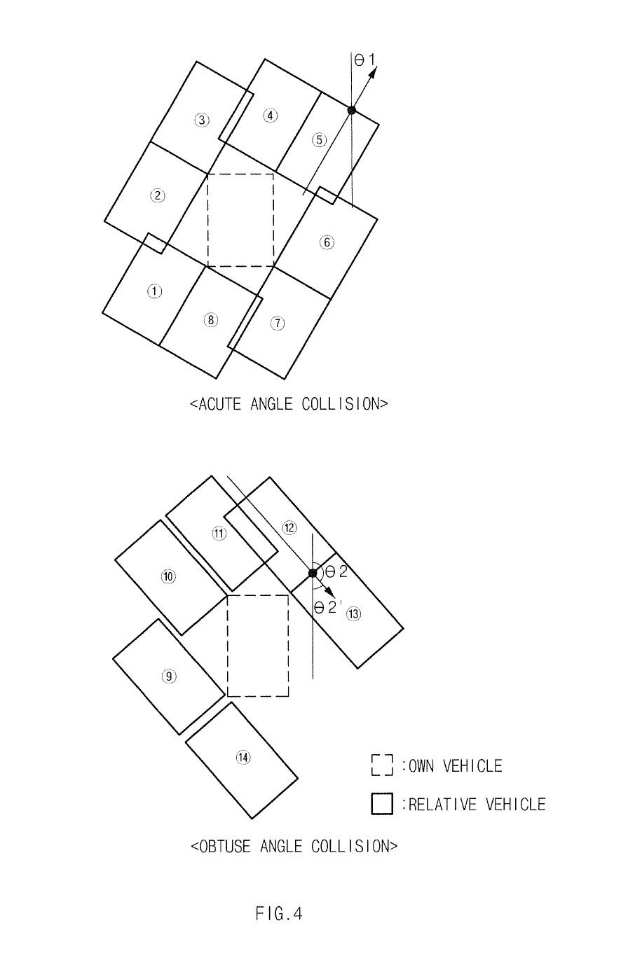

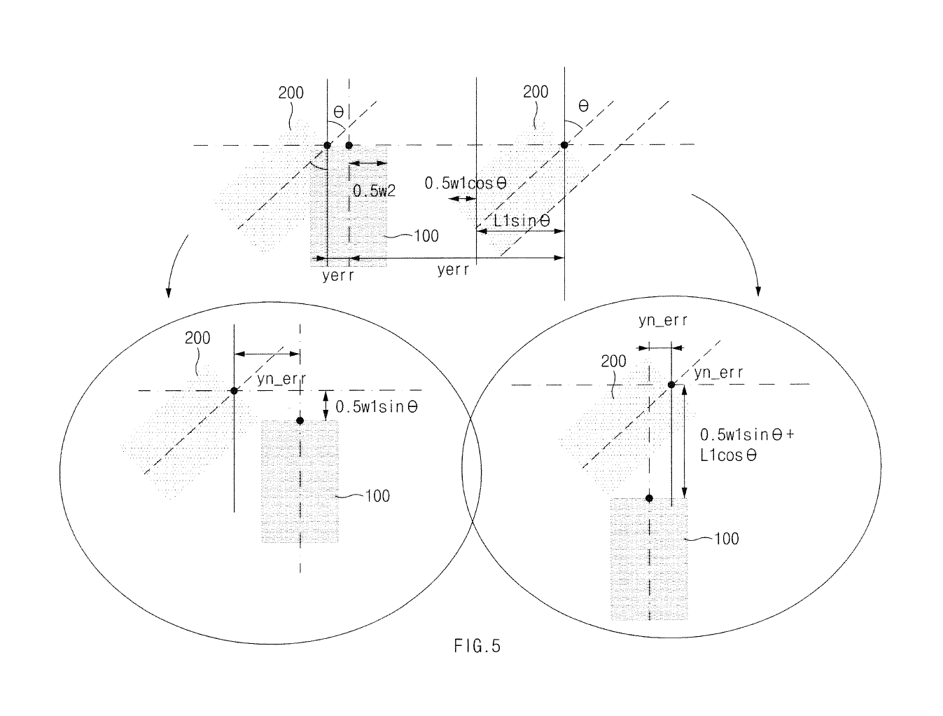

FIG. 1 is a block diagram illustrating a configuration of an apparatus for detecting a collision object of a vehicle according to an exemplary embodiment of the present disclosure, FIG. 2 is a view for describing a position relationship between an own vehicle and a relative vehicle according to the exemplary embodiment of the present disclosure, FIG. 3 is a view for describing calculation of a distance difference between the own vehicle and the relative vehicle in a transversal direction through coordination conversion according to the exemplary embodiment of the present disclosure, FIG. 4 is a view illustrating collision types according to the exemplary embodiment of the present disclosure, and FIG. 5 is a view for describing collision position calculation according to the exemplary embodiment of the present disclosure.

Referring to FIG. 1, the apparatus for detecting a collision object of a vehicle (hereinafter, referred to as an apparatus for detecting a collision object) according to an exemplary embodiment of the present disclosure is mounted in the vehicle and senses vehicles positioned in front of the vehicle to select (detect) a vehicle having high collision possibility as a collision object. The apparatus for detecting a collision object is configured to include a relative vehicle information obtaining unit 110, an own vehicle information obtaining unit 120, a memory 130, an output 140, and a processor 150 that are connected to each other through a vehicle network. Here, the vehicle network may be implemented by one or more by a controller area network (CAN), a media oriented systems transport (MOST) network, a local interconnect network (LIN), and a flexray.

The relative vehicle information obtaining unit 110 collects relative vehicle information through sensors (not illustrated) mounted in an own vehicle 100. The relative vehicle information includes a velocity, a movement direction, a relative position, a size (width and length), and the like, of a relative vehicle.

In other words, the relative vehicle information obtaining unit 110 calculates the velocity, the movement direction θ, and the relative position of the relative vehicle 200 based on data measured through an image sensor, a distance sensor (for example, an ultrasonic wave, a radar, etc), and the like. As illustrated in FIG. 2, the velocity of the relative vehicle 200 includes a longitudinal velocity Vfx and a transversal velocity Vfy of the relative vehicle 200, and the relative position includes a relative coordinate (X-direction value and Y-direction value from a reference position) and an angle α of the relative vehicle 200 based on a position of the own vehicle 100.

The own vehicle information obtaining unit 120 collects own vehicle information such as a velocity, a movement direction, and the like, of the own vehicle through sensors (not illustrated) mounted in the own vehicle. Here, the sensors (not illustrated) include a velocity sensor, a gyro sensor, a steering angle sensor, and the like.

The memory 130 stores own vehicle information such as a width, a length, and the like, of the own vehicle therein. In addition, the memory 130 stores the relative vehicle information and the own vehicle information collected through the relative vehicle information obtaining unit 110 and the own vehicle information obtaining unit 120 therein. The memory 130 stores various data generated in an operation process of the apparatus for detecting a collision object therein.

The output 140 outputs the collision object in an audiovisual form that may be recognized by a driver. The output 140 may be implemented by a display device, an audio device, and the like. The display device may include one or more of a liquid crystal display (LCD), a thin film transistor-liquid crystal display (TFT LCD), an organic light-emitting diode (OLED), a flexible display, a 3D display, a transparent display, a head-up display, and a touch screen.

The processor 150 calculates movement directions, vehicle velocities, a relative position, and the like, of each vehicle through prediction paths of the relative vehicle 200 and the own vehicle 100 to a specific point. Here, in the case in which the own vehicle 100 or the relative vehicle 200 turns, the prediction paths (movement trajectories) of each vehicle may be calculated by assuming that each vehicle is one point and applying a circle equation or a polynomial equation. In addition, the processor 150 performs a coordinate conversion using the movement direction of the own vehicle 100 as a reference axis to calculate a relative position (distance yerr between the own vehicle 100 and the relative vehicle 200 in a transversal direction) of the relative vehicle.

For example, as illustrated in FIG. 3, in the case in which the own vehicle 100 turns, a movement path of the own vehicle 100 is changed into an X axis based on a relative position yerr of the relative vehicle 200 and a movement direction θs of the own vehicle 100 at a point t1 in consideration of prediction paths of which the own vehicle 100 and the relative vehicle 200 moving up to the same line (t=t1), thereby calculating relative positions yerr′ and xerr′ of the relative vehicle 200.

The processor 150 selects a collision type depending on a relationship k between a relative velocity of the relative vehicle 200 in the transversal direction and a relative velocity of the relative vehicle 200 in a longitudinal direction and access angles θ₁ and θ₂ of the relative vehicle. In other words, as illustrated in FIG. 4 and Table 1, the processor 150 divides the collision type based on the access angle and the relative velocity of the relative vehicle 200.

In Table 1, W₁ is a width of the relative vehicle, W₂ is a width of the own vehicle, L₁ is a length of the relative vehicle, L₂ is a length of the own vehicle, θ₁ and θ₂ are access angles (movement direction of the relative vehicle or collision angle) of the relative vehicle, θ_{2′}=180°−θ₂, k is a ratio

$$( \frac{Vry}{Vrx} )$$

between a velocity difference Vry between the own vehicle and the relative vehicle in the transversal direction and a velocity difference Vrx between the own vehicle and the relative vehicle in the longitudinal direction, A=cos θ₁−k sin θ₁, B=sin θ₁+k cos θ₁, and C=sin θ_{2′}−k cos θ_{2′}.

For example, in the case in which the collision type is Case 1, a maximum value of the distance yerr between the own vehicle and the relative vehicle in the transversal direction is 0.5 W₂+0.5 W₁ cos θ₁+k (L₂−0.5 W₁ sin θ₁), and a minimum value thereof is −0.5 W₂−0.5 W₁ cos θ₁−L₁ sin θ₁+k(−L₁ cos θ₁+0.5 W₁ sin θ₁).

TABLE 1

| | | | | | | Obtuse Angle | |
|---|---|---|---|---|---|---|---|
| | | Acute Angle(0 ≦ θ₁ ≦ 90) | | | | (90 < θ₂ ≦ 180) | |
| | | Case 1 | Case 2 | Case 3 | Case 4 | Case 5 | Case 6 |
| Division | yerr | k ≧ 0, A ≧ 0 | K > 0, A < 0 | K < 0, B ≧ 0 | k < 0, B < 0 | C ≧ 0 | C < 0 |
| 1 | 0.5W₂ + 0.5W₁cosθ₁ + k(L₂ − 0.5W₁sinθ₁) | 1 | 2 | 2 | 3 | | |
| 2 | 0.5W₂ + 0.5W₁cosθ₁ + k(−0.5W₁sinθ₁) | 2 | 3 | 1 | 2 | | |
| 3 | 0.5W₂ + 0.5W₁cosθ₁ − | 3 | 4 | | 1 | | |
| | L₁sinθ₁ + k(−L₁cosθ₁ − 0.5W₁sinθ₁) | | | | | | |
| 4 | −0.5W₂ + 0.5W₁cosθ₁ − | 4 | 5 | | | | |
| | L₁sinθ₁ + k(−L₁cosθ₁ − 0.5W₁sinθ₁) | | | | | | |
| 5 | −0.5W₂ − 0.5W₁cosθ₁ − | 5 | | | | | |
| | L₁sinθ₁ + k(−L₁cosθ₁ + 0.5W₁sinθ₁) | | | | | | |
| 6 | −0.5W₂ − 0.5W₁cosθ₁ − | | | 5 | | | |
| | L₁sinθ₁ + k(L₂ − L₁cosθ₁ + 0.5W₁sinθ₁ | | | | | | |
| 7 | −0.5W₂ − 0.5W₁cosθ₁ + k(L₂ + 0.5W₁sinθ₁) | | | 4 | 5 | | |
| 8 | 0.5W₂ − 0.5W₁cosθ₁ + k(L₂ + 0.5W₁sinθ₁) | | 1 | 3 | 4 | | |
| 9 | 0.5W₂ − 0.5W₁cosθ₂ + k(L₂ + 0.5W₁sinθ₂) | | | | | 1 | 2 |
| 10 | 0.5W₂ − 0.5W₁cosθ₂ + k(0.5W₁sinθ₂) | | | | | 2 | 3 |
| 11 | 0.5W₂ − 0.5W₁cosθ₂ + k(−0.5W₁sinθ₂) | | | | | 3 | 4 |
| 12 | −0.5W₂ − 0.5W₁cosθ₂ + k(−0.5W₁sinθ₂) | | | | | 4 | 5 |
| 13 | −0.5W₂ − 0.5W₁cosθ₂ − | | | | | 5 | |
| | L₁sinθ₂ + k(L₁cosθ₂ − 0.5W₁sinθ₂) | | | | | | |
| 14 | 0.5W₂ − 0.5W₁cosθ₂ − | | | | | | 1 |
| | L₁sinθ₂ + k(L₂ + L₁cosθ₂ + 0.5W₁sinθ₂) | | | | | | |

When the collision type is selected, the processor 150 calculates a distance yn_err between the own vehicle and the relative vehicle in the transversal direction in the selected collision type, thereby making it possible to calculate a collision point in time t2 through a relationship between the distance yn_err and an existing yerr.

The processor 150 calculates a collision position of the vehicle through the relative position (yerr or yerr′) of the relative vehicle 200. Here, it is assumed that the own vehicle 100 and the relative vehicle 200 linearly move. The reason is that a direction of a trajectory may not be rapidly changed in a situation in which the vehicle is close to a collision position.

As illustrated in FIG. 5, it is assumed that the own vehicle 100 and the relative vehicle 200 are points, respectively, a distance yerr between the two points (own vehicle 100 and relative vehicle 200) in the transversal direction is calculated when the two points arrive at the same line (t=t1), and areas of the own vehicle 100 and the relative vehicle 200 are applied based on the two points to confirm whether or not the own vehicle 100 and the relative vehicle 200 collide with each other. Here, when the own vehicle 100 and the relative vehicle 200 are in a state in which they collide with each other (state in which the areas of the own vehicle and the relative vehicle are partially overlapped with each other), a distance yn_err between the two points in the transversal direction is calculated at a collision point t2. In addition, the processor 150 calculates a time t2 just before collision using the distance yerr in the transversal direction at the point t1, the distance yn_err in the transversal direction at the point t2, and a velocity difference Vry between the own vehicle 100 and the relative vehicle 200 in the transversal direction. Here, the time t2 just before collision may be represented by the following Equation 1.

$$t 2 - \frac{yerr - yn\_err}{Vry} \qquad [ Equation 1 ]$$

The processor 150 calculates a time to collision (TTC) (=t1+t2) using the point in time t1 in which the own vehicle and the relative vehicle arrive at the same line (X axis) and the collision point in time t2 of the own vehicle and the relative vehicle. In addition, the processor 150 may calculate a collision overlap and a collision angle using the distance between the own vehicle and the relative vehicle in the transversal direction and the vehicle information of each vehicle.

The processor 150 may select collision objects among all the vehicles sensed through the TTC, the collision overlap, and the collision angle, and determine a priority depending on a collision danger level.

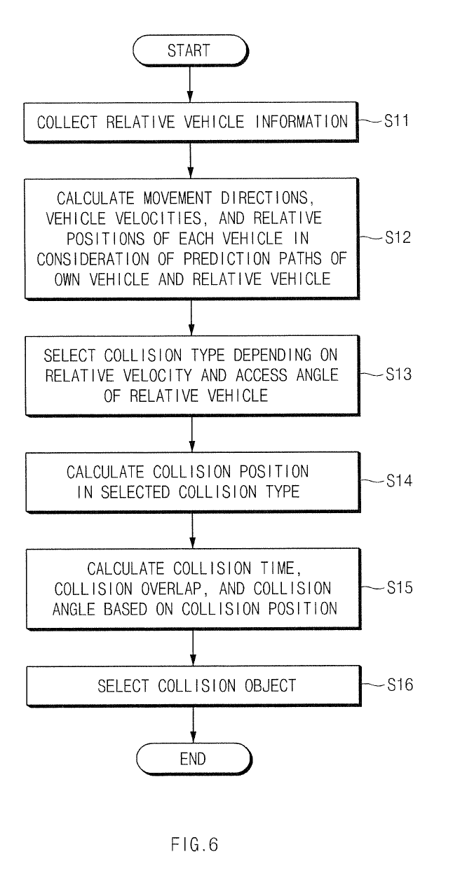

FIG. 6 is a flow chart illustrating a method for detecting a collision object of a vehicle according to the exemplary embodiment of the present disclosure.

Referring to FIG. 6, the processor 150 of the apparatus for detecting a collision object of a vehicle obtains the relative vehicle information through the relative vehicle information obtaining unit 110 (S11). The relative vehicle information includes the velocity (longitudinal velocity and transversal velocity), the movement direction, the relative position, the width, and the length of the relative vehicle.

Then, the processor 150 calculates movement directions, vehicle velocities, and relative positions (distance between the own vehicle and the relative vehicle in the transversal direction) of each vehicle in consideration of prediction paths of the own vehicle and the relative vehicle (S12). In this step, the processor 150 calculates the movement directions, the vehicle velocities, and the relative positions yerr of each vehicle in consideration of movement paths of the own vehicle and the relative vehicle until the own vehicle and the relative vehicle arrive at the same line (X axis). Here, the processor 150 calculates the relative position of the relative vehicle through the coordination conversion using the movement direction of the own vehicle as the reference axis in the case in which the own vehicle turns.

Next, the processor 150 selects the collision type depending on the relative velocity and the access angle of the relative vehicle (S13). In this step, the processor 150 decides whether or not the own vehicle and the relative vehicle collide with each other in consideration of the relative position of the relative vehicle and sizes (widths and lengths) of the own vehicle and the relative vehicle. In addition, the processor 150 may calculate a collision range based on the above Table 1.

Next, the processor 150 calculates the collision position yn_err between the own vehicle and the relative M vehicle in the selected collision type (S14). In this step, the processor 150 calculates the distance between the own vehicle and the relative vehicle in the transversal direction at the collision position depending on the collision type.

Next, the processor 150 calculates the collision time, the collision overlap, and the collision angle based on the collision position (S15). In this step, the processor 150 calculates the collision point in time using the distance between the own vehicle and the relative vehicle in the transversal direction on the same line, the distance between the own vehicle and the relative vehicle in the transversal direction at the collision position, and the relative velocity in the transversal direction. In addition, the processor 150 calculates the TTC using the point in time in which the own vehicle and the relative vehicle arrive at the same line and the collision point in time.

Then, the processor 150 selects the collision object among one or more front vehicles sensed in front of the own vehicle based on the calculated collision time, collision overlap, and collision angle (S16).

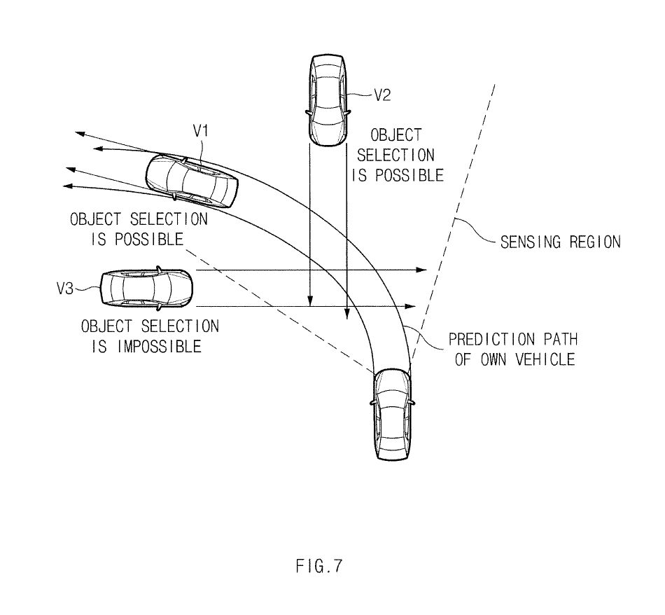

According to the above-mentioned exemplary embodiment, as illustrated in FIG. 7, a vehicle having collision possibility between vehicles V1 and V2 positioned in a sensible space (sensing region) in front of the own vehicle may be selected as the collision object.

Therefore, in the present disclosure, it may be decided whether or not the own vehicle will collide with all vehicles such as an oncoming vehicle, a cross vehicle, a cut-in vehicle, a cut-out vehicle, and the like, thereby making it possible to select the collision object and control collision avoidance when a collision situation with the vehicles as described above occurs.

As described above, according to the exemplary embodiments of the present disclosure, vehicles positioned in front of the vehicle may be sensed using the sensors mounted in the vehicle, and a vehicle having collision possibility among the sensed vehicles may be selected. Therefore, according to the exemplary embodiments of the present disclosure, it may be decided whether or not the own vehicle and a vehicle crossing with the own vehicle collide with each other (side collision), whether or not the own vehicle and a vehicle moving in an opposite direction to a direction in which the own vehicle moves collide with each other (front collision), and the like, as well as whether or not the own vehicle and a vehicle positioned on the same path as that of the own vehicle collide with each other.

In the exemplary embodiments described hereinabove, components and features of the present disclosure were combined with each other in a predetermined form. It is to be considered that the respective components or features are M selective unless separately explicitly mentioned. The respective components or features may be implemented in a form in which they are not combined with other components or features. In addition, some components and/or features may be combined with each other to configure the exemplary embodiment of the present disclosure. A sequence of operations described in the exemplary embodiments of the present disclosure may be changed. Some components or features of any exemplary embodiment may be included in another exemplary embodiment or be replaced by corresponding components or features of another exemplary embodiment. It is obvious that claims that do not have an explicitly referred relationship in the claims may be combined with each other to configure an exemplary embodiment or be included in new claims by amendment after application.

Exemplary embodiments of the present disclosure may be implemented by various means, for example, hardware, firmware, software, or a combination thereof, etc. In the case in which an exemplary embodiment of the present disclosure is implemented by the hardware, it may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case in which an exemplary embodiment of the M present disclosure is implemented by the firmware or the software, it may be implemented in a form of a module, a procedure, a function, or the like, performing the functions or the operations described above. A software code may be stored in a memory unit and be driven by a processor. The memory unit may be positioned inside or outside the processor and transmit and receive data to and from the processor by various well-known means.

It is obvious to those skilled in the art that the present disclosure may be embodied in another specific form without departing from the feature of the present disclosure. Therefore, the above-mentioned detailed description is to be interpreted as being illustrative rather than being restrictive in all aspects. The scope of the present disclosure is to be determined by reasonable interpretation of the claims, and all modifications within an equivalent range of the present disclosure fall in the scope of the present disclosure.

What is claimed is:

1. A method for detecting a collision object of a vehicle, comprising:
sensing one or more relative vehicles positioned in front of an own vehicle through sensors provided in the own vehicle and collecting relative vehicle information on the sensed relative vehicles;
calculating relative positions of the relative vehicles when the own vehicle and the relative vehicles arrive at the same line in consideration of prediction paths of the own vehicle and the relative vehicles;
selecting a collision type depending on relative velocity relationships and access angles of the relative vehicles;
calculating a collision position between the own vehicle and the relative vehicles in the selected collision type;
calculating collision information based on the collision position; and
selecting a collision object among the one or more relative vehicles based on the collision information.

2. The method for detecting a collision object of a vehicle according to claim 1, wherein the relative vehicle information includes a velocity, a movement direction, a relative position, a width, and a length of the relative vehicle.

3. The method for detecting a collision object of a vehicle according to claim 2, wherein the relative position is a distance between the own vehicle and the relative vehicle in a transversal direction.

4. The method for detecting a collision object of a vehicle according to claim 1, wherein in the calculating of the relative positions of the relative vehicles, distances between the own vehicle and the relative vehicles in a transversal direction are calculated in a point in time in which the own vehicle and the relative vehicles arrive at the same line.

5. The method for detecting a collision object of a vehicle according to claim 1, wherein the prediction paths are calculated by assuming that each vehicle is movement of points and applying a circle equation or a polynomial equation.

6. The method for detecting a collision object of a vehicle according to claim 1, wherein the selecting of the collision type includes deciding whether or not the own vehicle and the relative vehicle collide with each other based on sizes of the own vehicle and the relative vehicle.

7. The method for detecting a collision object of a vehicle according to claim 1, wherein the collision information includes a time to collision (TTC) between the own vehicle and the relative vehicle, a collision overlap, and a collision angle.

8. The method for detecting a collision object of a vehicle according to claim 7, wherein the calculating of the collision information includes:
calculating a collision point in time using a distance between the own vehicle and the relative vehicle in a M transversal direction on the same line, a distance between the own vehicle and the relative vehicle in the transversal direction at the collision position, and a relative velocity in the transversal direction; and
calculating the TTC using a point in time in which the own vehicle and the relative vehicle arrive at the same line and the collision point in time.

9. An apparatus for detecting a collision object of a vehicle, comprising:
a relative vehicle information obtaining unit configured to sense one or more relative vehicles positioned in front of an own vehicle through sensors provided in the own vehicle and collect relative vehicle information on the sensed relative vehicles;
an own vehicle information obtaining unit configured to collect information on the own vehicle; and
a processor configured to calculate relative positions of the relative vehicles when the own vehicle and the relative vehicles arrive at the same line in consideration of prediction paths of the own vehicle and the relative vehicles, select a collision type depending on relative velocity relationships and access angles of the relative vehicles, calculate a collision position between the own vehicle and the relative vehicles in the selected collision type, calculate collision information M based on the collision position, and select a collision object among the one or more relative vehicles based on the collision information.

10. The apparatus for detecting a collision object of a vehicle according to claim 9, wherein the relative vehicle information includes a velocity, a movement direction, a relative position, a width, and a length of the relative vehicle.

11. The apparatus for detecting a collision object of a vehicle according to claim 9, wherein the own vehicle information includes a width, a length, a movement direction, and a vehicle velocity of the own vehicle.

12. The apparatus for detecting a collision object of a vehicle according to claim 9, wherein the processor calculates the prediction paths by assuming that the own vehicle and the relative vehicle are one points and applying a circle equation or a polynomial equation.

13. The apparatus for detecting a collision object of a vehicle according to claim 9, wherein the processor calculates the collision position between the own vehicle and the relative vehicle in consideration of widths and lengths of the own vehicle and the relative vehicle.
